(19) United States
(12) Patent Application Publication
(10) Pub. No.: US 2017/0211541 A1
(43) Pub. Date: Jul. 27, 2017

(54) Docked Boats/Ships Harvest Energy from Tides

(71) Applicant: Roger Alan Ramsey, Ashland, OR (US)

(72) Inventor: Roger Alan Ramsey, Ashland, OR (US)

(21) Appl. No.: 15/005,557

(22) Filed: Jan. 25, 2016

(51) Int. Cl. F03B 13/26; F03B 13/10

(52) U.S. Cl. CPC F03B 13/262; F03B 13/10; B63B 2035/4466

(57) ABSTRACT

An energy producing device which employs the effect of tides on docked boats to create power, by means of compressing and extending a bag tank located below the docked boat. This system will produce energy as the bag is compressed and extended. Including at least one non-permeable bag with its base staked in place on the ocean floor. The bag tank will have a rigid frame above it, which is pulled tight to the bottom of a docked boat with lines and is connected by elastic fabric or cord to the bag tank. A tube that works as a depth gage and guides a T handled rod with an end that can operate a hatch control. Floats and lines to secure and keep the rigid frame and bag tank up in times when the boat is out of the harbor. Through fittings at the bottom of the tank connected to plumbing, which is connected to a hydro generator and waste pipe which also works as an inlet when the bag tank is extending.

### BACKGROUND

The inventive matter disclosed herein is directed to a means for generating power from tides by vessels tied up to docks and floats. While at the dock they area raised and lowered by the ocean tides. There is a lot of energy that could be harnessed from the raising and lowering of these vessels.

Fishing boats, work boats, pleasure boats and cruise ships of all sizes spend much of their time in port tied up at docks. While tied up at the dock, these boats can utilize the power created from the tides to energize the vessels and the local grid

Most harbors are next to population centers which use electricity and typically there is shore power accessible to the vessels docked at the harbor. Therefore if power could be generated by the interface of the vessel with the tides it could easily be transferred to the local grid.

### SUMMARY

The inventive subject matter offers a solution to harvesting power from these moored vessels with the following qualities alone or in combination.

The invented device is comprised of a structurally reinforced non permeable bag tank, with one or more fittings toward its base where plumbing could be attached. Said bag tank is rectangular in shape with its base resting on the sea floor. The base of said bag tank is prevented from moving by stakes on the outside of the bag tank, driven or screwed into the seafloor. The bag tank is tall enough to rise to a height where it would have contact with the keel of the boat and the seafloor or base platform at all tides. Hatches are on the top of the bag tank allowing it to be extended upward easily when they are open and when they are closed the water that must fill or leave the bag as the bag tank is compressed or extended, must be forced through the fitting(s). Attached to the top of said bag tank by means of pliant material is a rigid framework. The rigid frame work is made secure to the keel of the vessel by lines at least fore, middle and aft on the cleats of the vessel on both the port and starboard sides, or all the way over the deck.

Now as the vessel reacts to the tide raising it or lowering it, the bag tank is either compressed or extended. As the bag tank is extended up from the tide raising the vessel, water is sucked through the fitting(s) into the bag tank. As the bag tank is compressed from the vessel's weight pushing down as the tide goes out water is pushed out of the fitting or fittings. The said fitting(s) would be sealed to flexible pipe or pipes connected to a hydro generating system properly sized and controlled for the flow being generated. The sealed pipe(s) would then continue out of the generating system back into the waterbody, with a screened end being deep enough to avoid floating debris and air intake. When the vessel then begins to rise on the incoming tide, it pulls water back through the hydro generating system and into the now extending bag tank, preparing it for when it will be compressed on the next outgoing tide.

The foregoing is not intended to be an exhaustive list of the embodiments of features of the inventive subject matter. Persons skilled in the art are capable of appreciating other embodiments and features from the following detailed description in connection with the drawings.

### BRIEF DESCRIPTION OF THE DRAWINGS

The figures, on the following pages, show embodiments according to inventive subject matter, unless noted as showing prior art.

### Figure Descriptions

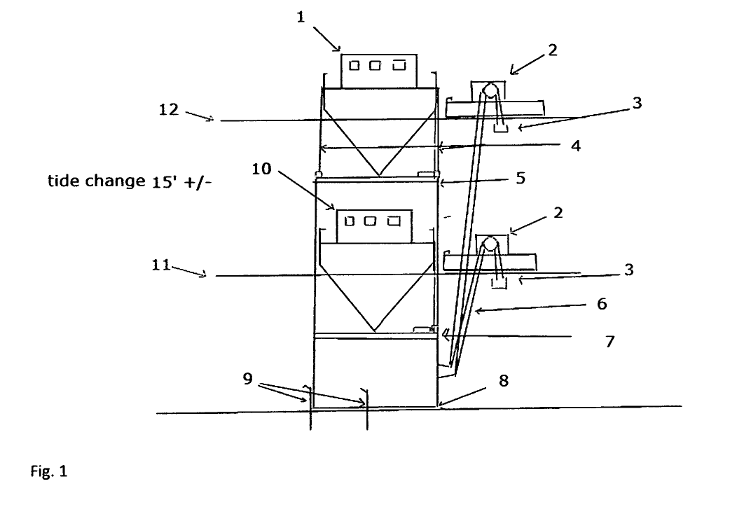

FIG. 1 shows the overview of the invention, with the invention at both high and low tide. In this figure the compressed and extended up position of the bag tank are depicted. The depiction shows a tide change of 15 feet. The flexible pipe that connects the bag tank to the generator coils down at low tide.

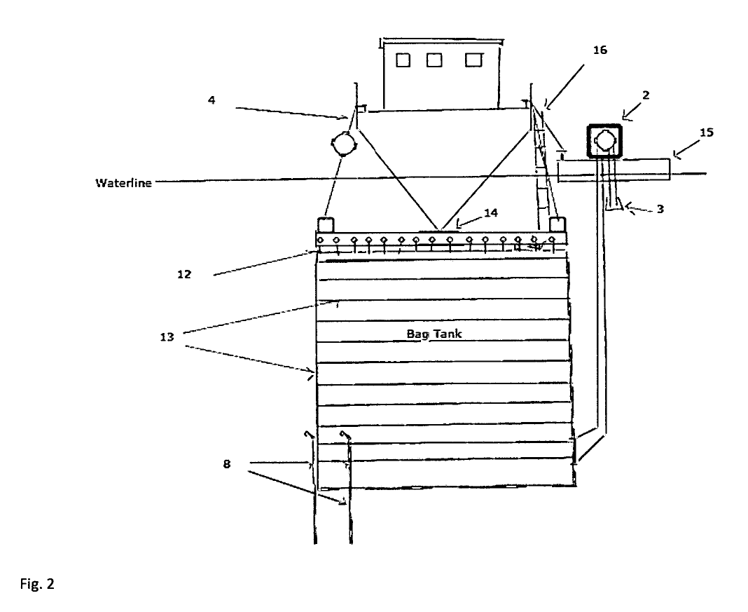

FIG. 2 (Front page view) is a depiction of the system as a whole, with the boat at the dock, in working position. It generally shows all the systems needed to operate the bag tank generating system.

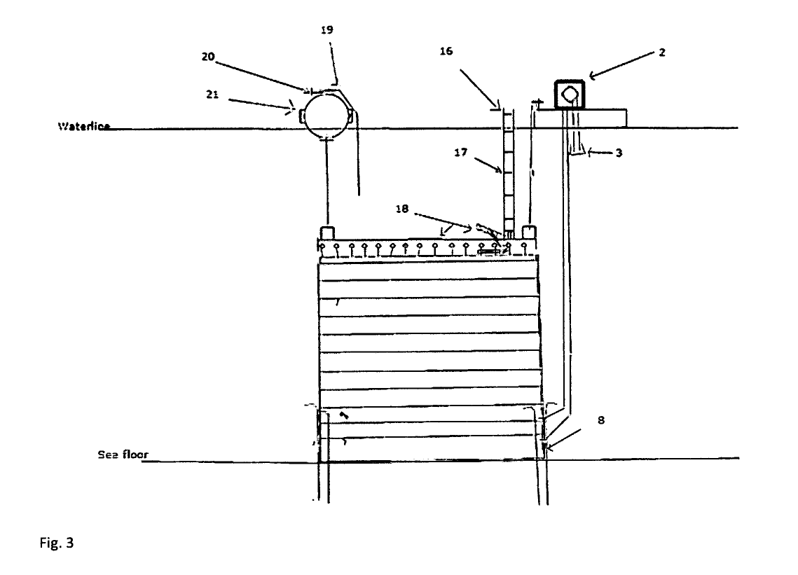

FIG. 3 Shows the bag tank in resting position, when the boat is gone. The weight of the tank and rigid frame will be held up by the dock and bouy floats (sized appropriately). As can be seen, in resting position, the bagtank will sit lower in the water allowing for the boat to come into port without hitting it. The bouy floats will have a binding mechanism that can be used to adjust the depth. Also note in the resting position the hatchs will always be open to allow the bag to move up and down with no tension from water being forced through the fittings(s) and pipe that goes to the the generator.

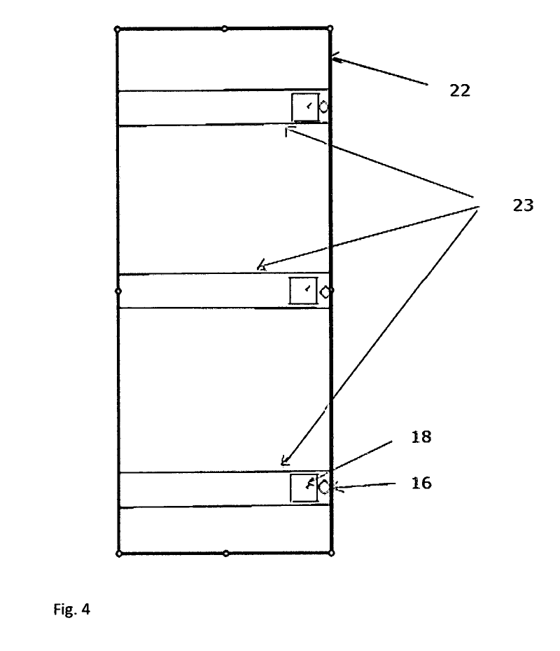

FIG. 4 depicts the rigid frame that the bag tank is attached to, along with the rigid cross members that will be pulled up against the keel of the vessel. It also shows the hatches that are in place. The hatches will be opened when the bag is pulled up as it is being deployed against the keel. Without the hatches open the bag tank could not be pulled up against the keel of the boat easily. Once it is against the keel the hatches are closed so that only the outlets to the generator allow water in and out of the tank. The hatch control tube guides a rod with a fork at the end to the hatch controller.

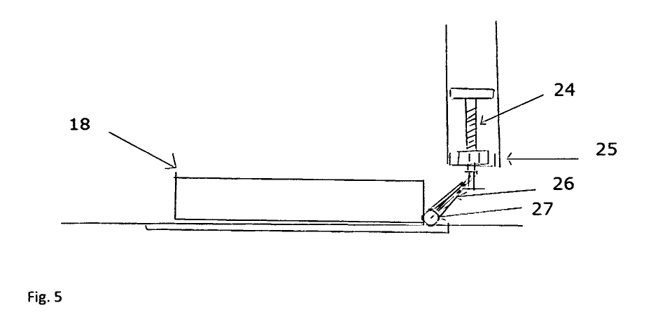

FIG. 5 shows the hatch and its controls. As the threaded bolt is screwed down it will push down on the control arm and lift the hatch. As it is screwed up the extended node on the bottom of the bolt will pull up on the control arm and close the hatch to make it non-permeable. The U channel is made fast to the hatch base. The screw will be turned by a T handled rod with a fork on the end.

### FIGURE NUMBER CORRELATION

1. Vessel at high tide
2. Hydro generator
3. Screened outlet spews water as bag compresses and sucks water as it extends.
4. Lines pull up and hold rigid frame and bag tank to keel of boat
5. Flexible pipe coils down when tide is out.
6. Bag tank top compressed
7. Bag tank bottom
8. Stakes holding bag tank to sea floor.
9. Vessel at low tide.
10. Waterline at low tide.
11. Waterline at high tide.
12. Pliant cord or material attaches bag tank to frame. The pliant cord or material interface is critical to keep the bag tank from wear and tear when there is sudden up and down movement from waves and wind.
13. Laminated in between non-permeable material is wire reinforcing, shaped in a rectangle. This makes the bag act as an accordion bag or bellows.
14. The rubber or non-abrasive material which the keel will rest on.
15. Dock that the generator sits on.
16. The hatch control tube, which will be stiff and supported at the base and somewhat flexible above the waterline. The hatch control tube will also indicate the depth of the water above the rigid frame.
17. Depth indicator lines on Hatch control tube.
18. Hatch—Hatch opens when not in uses and is closed for in use position.
19. Excess line for pulling bag tank up to boat.
20. Line binding mechanism in buoy float.
21. Through line floats sized to hold up bag tank when hatch is open.
22. Rigid external frame
23. Rigid cross members
24. Threaded control bolt, screws down to open and screws up to close.
25. Nut welded to U channel.
26. Control arm.
27. Hinge on Hatch

### DETAILED DESCRIPTION

Representative embodiments according to inventive subject matter are shown in the foregoing FIGS. 1-5.

The inventive subject matter is directed to a novel device which creates energy from the interface of boat tied up at a dock and the rise and fall of the ocean tides.

The device contains one non permeable bag tank, reinforced to hold its rectangular shape, which can be compressed shorter or extended taller. The bottom of this bag tank will be rested on and attached to the ocean floor, while the top will be made fast to the bottom of a vessel. The bag will be full of water and there will be a fitting(s) that can be connected to pipe(s) that allows the water inside the tank to proceed through the pipe(s). When the bag is depressed by the weight of the boat as the ocean tides ebbs or recedes, water is pushed from inside the bag tank through the pipe(s) and into a hydro generator(s). Once the water goes through the hydro generator(s) it will be piped as waste to a location below the ocean water line.

This same waste pipe will then act as an intake pipe when the tide rises and the boat is raised up. The boat pulls up extends the tank by means of secure attachments to the boat which is rising on the tide.

For an example of how this would work consider a SE Alaska Limited Seine boat. These boats are 58 foot in length. Have a width of around 20′. They weigh around 200,000 Lb. If a 20′×50′ bag tank were placed underneath one of these boats in a port like Juneau Ak. where the tide changes average around 15 feet, the cubic feet of water displacement from the tank being compressed and into the tank when it is extended can be calculated as follows. 20′×50′×15=15,000 cubic feet multiplied by 7.47 (gallon per cubic feet gives a total of 112,050 gallons displaced on one average 6 hour tide cycle. Dividing 112,050 by 6 hours gives 18,675 gallons per hour. Dividing 18,675 per hour by 60 gives us 311 gallons per minute. That then equals 5.18 gallons per second that would be run through the generator. As can be seen this would be significant flow.

This inventive subject matter does not calculate the strength of the material needed nor the piping dimensions or hydro generator specifics. This would need to be completed by experts in each of these fields.

### Operation

At rest the bag tank will be hanging by both the dock and flotation buoys with the hatches open, with the top of the tank at a level below the keel of the boat. When the boat comes back to the harbor to tie up it will come into its usual stall over the top of the bag tank and tie up to the dock. The lines holding up the bag tank will be pulled up manually or mechanically to the proper height where the rigid frame work of the tank is level and tight up against the bottom of the keel. Once this is in place the hatches will be closed using the T handled rod with a fork on the end. Once the hatches are closed any movement up or down from the boat will push or pull water through the generator creating energy.

1. A non-permeable bag tank with fitting(s) and hatches that can be made fast to the bottom of a boat and also be resting on and attached to the sea floor or solid platform, so that when the tide ebbs and the sea level lowers the bag will be compressed pushing water through the fitting(s). Likewise when the tide rises the bag will extend pulling water into the bag through the fitting(s).

2. A tube that works as both a depth gage and guide to operate the controls of a hatch.

3. A kit comprising of the aforementioned bag tank, rigid framed top, connecting material for connecting bag tank to rigid frame, a tube that works as both a depth gage and guide to operate the controls of a hatch, pipe(s), hydro generator, lines for securing rigid frame to boat and docks and floats.

4. A method for making an electrical generating system with a boat and bag tank according to claims 1-3.

5. A method for using electrical generating system with a boat and bag tank according to claims 1-3.
